(19) United States
(12) Patent Application Publication
(10) Pub. No.: US 2022/0088670 A1
(43) Pub. Date: Mar. 24, 2022

(54) CASTING MODULES AND SYSTEMS AND METHODS FOR MODULE-BASED CASTING

(71) Applicant: DDM SYSTEMS, INC., Atlanta, GA (US)

(72) Inventor: Suman DAS, Atlanta, GA (US)

(73) Assignee: DDM SYSTEMS, INC., Atlanta, GA (US)

(21) Appl. No.: 17/424,928

(22) PCT Filed: Jan. 22, 2020
(86) PCT No.: PCT/US2020/014635

§ 371 Date: Jul. 22, 2021

Related U.S. Application Data
(60) Provisional application No. 62/795,224, filed on Jan. 22, 2019.

(51) Int. Cl. B22C 9/08; B29C 33/38; G06F 30/10

(52) U.S. Cl. CPC B22C 9/08; B29C 2033/3871; G06F 30/10; B29C 33/38

(57) ABSTRACT

A method including: obtaining a part design file of a part; deriving, from the art design file, a central mold design; determining one or more fill points for the central mold design; and attaching one or more mating connectors to the determined one or more fill points to create a modular part mold file.

### CROSS-REFERENCE TO RELATED APPLICATIONS

This application claims the benefit of U.S. Provisional Application No. 62/795,224 filed Jan. 22, 2019, the entirety of which is incorporated by reference as if set forth in full below.

### FIELD

The presently disclosed subject matter relates generally to part casting and, more particularly, to casting modules and systems and methods for enabling and providing module-based casting.

### BACKGROUND

Investment casting or “lost-wax casting” is a well-established metal-forming technique. In the traditional approach, (typically wax) models are formed into a “tree” assembly with a central sprue (“trunk”), individual part models, and a filling cup. In some cases, “branches” or arms may extend from the sprue to the individual part models. A ceramic mold (investment) is made by coating the tree assembly and stuccoing and hardening the slurry. The coating, stuccoing and hardening are repeated until the investment has a desired thickness. The ceramic molds are then dried, which can take several days. Once ceramic molds are dried, they are turned upside-down and heated (e.g., in a furnace or autoclave) to melt out and/or vaporize the wax. The dewaxing process is a common source for failure as the waxes have a much greater thermal expansion coefficient than the ceramic mold. Thus, as the wax is heated, it rapidly expands and can crack the mold. Once the mold is prepared, metal is poured into the ceramic mold, filling the mold. The metal may be gravity poured or forced in (e.g., by applying positive air pressure). The mold may also be filled using, for example, vacuum casting, tilt casting, pressure assisted pouring and centrifugal casting. The metal is cooled, and the cast is broken away from the cooled metal. The parts are cut off from the sprue and finished. The sprue and branches in the traditional approach can require as much metal as the cast parts themselves, wasting both resources and energy (e.g., in heating and re-melting the metal).

The traditional approach is a laborious and time-consuming process that may lead to failure after hours or days of effort. Moreover, such approaches can create uncontrollable shell-sizes, which create unpredictable solidification and cooling effects. This can cause unacceptable or defective castings (e.g., if specific crystal structures needed for the parts are not achieved). Certain related art methods attempt to address some of these issues utilizing three-dimensional (3D) printing techniques to directly produce ceramic castings. With 3D printing, a mold CAD file is provided to a 3D printer-system which produces a complete ceramic mold. Certain approaches to 3D printing are known to those of ordinary skill, such as those discussed in PCT Publication App. PCT/US2013/069349 filed on Nov. 11, 2013 and published as WO2014/074954 on May 15, 2014, the disclosure of which is incorporated herein by reference in its entirety as if fully restated, and variations thereto will be obvious to one of ordinary skill in light of the present disclosure.

However, even with 3D printing, there continue to be limitations to the related art approaches. For instance, with an entire ceramic mold produced as a solid piece may require reproduction of the entire mold if a single portion is fails (e.g., is damaged in transit or during pouring). Moreover, it may be inefficient to produce small-number-of-parts batch runs as attaching more parts to a single sprue mold is typically more resource and cost effective. Therefore, what is needed is a way to improve the efficiency and flexibility of investment casting.

### SUMMARY

According to some embodiments, there is provided a method including: obtaining a part design file of a part; deriving, from the art design file, a central mold design; determining one or more fill points for the central mold design; and attaching one or more mating connectors to the determined one or more fill points to create a modular part mold file.

According to some embodiments, there is provided a method including: obtaining sprue mold connector requirements; deriving, from the sprue mold connector requirements, sprue mold dimensions; generating a sprue mold outline in accordance with the sprue mold dimensions; and attaching one or more virtual connectors to the sprue mold outline to create a sprue mold file.

According to some embodiments, there is provided a modular part mold comprising: a shell defining a central void; and a mating connector attached to the shell and configured to mate with a connector of a modular sprue mold at an interface surface of the mating connector.

According to some embodiments, there is provided a modular sprue mold comprising: a shell defining a central void; a plurality of mating connector attached to the shell and configured to mate with a respective connectors of one or more modular part molds at an interface surface of the mating connector; and a fill cup.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a flowchart of conventional investment casting of 3D objects.

FIG. 2 is a perspective view of an example 3D printing system.

FIGS. 3-4 are flowcharts of investment casting three-dimensional objects according to example embodiments.

FIG. 5 is a flowchart of creating modular part molds according to an example embodiment.

FIG. 6 is a flowchart of creating modular sprue molds according to an example embodiment.

FIGS. 7A-7C illustrate example modular sprue mold and part molds according to an example embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices, systems, and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

According to some embodiments, modular sprue, arm, and part molds (e.g., modules) may be formed and/or printed separately. The sprue mold may be formed with connectors (e.g. gates and/or runners) spaced along the central column of the sprue mold. Similarly, the part molds may have mating connectors formed at one end. When a plurality of parts are desired, corresponding part molds and a relevantly sized sprue mold are selected. The parts are connected to respective connectors in the sprue mold. If any sprue mold connectors are unfilled (e.g., because more connectors than desired parts and/or part sizes do not match connector placement), plugs may be secured in the unfilled sprue mold connectors. In some cases, clamps, ceramic glue and/or other adhesive is used to secure and/or seal the connections between the sprue mold and part molds and plugs. The assembled tree mold may then be used for casting (e.g., gravity poured, vacuum casting, tilt casting, pressure assisted pouring and centrifugal casting) as will be understood by one of ordinary skill.

According to some embodiments, there may be a process for creating modular part molds. A part CAD file may be provided. A negative of the CAD file may be built, and a connection point may be determined. Building the negative of the CAD file may include defining a surface of the part and thickening the surface to make a shell of predeterminable thicknesses. In some implementations, the shell thicknesses and materials may be adjusted to tailor local heat transfer (e.g., to control solidification and subsequent cooling of a cast part). In some instances, channels may be placed into the shell to allow faster local heat transfer. In some cases, portions of the shell may be made with different materials (e.g., materials with different thermal conductivity and/or heat capacity) to control local heat transfer. A virtual mating connector may be added to the connection point to form a modular part mold CAD file. The virtual mating connector is dimensioned to mate with a connector formed on a sprue mold. In some cases, a virtual channel with a virtual connector on its far end may be added to the connector portion. In some cases, a plurality of connection points may have respective channels that feed into the virtual connector. In some cases, the connection points may be connected to one or more mating connectors as a gating system to allow metal to flow into the modular part mold. For example, the gating system may allow metal to flow into one or more of the top, bottom, or sides of the modular part mold. One or more modular part molds may be created using a 3D production process (e.g., using a 3D printer) as would be understood by one of ordinary skill in light of the present disclosure. In some embodiments, venting seams, porous outlets (e.g., with pores large enough for air molecules to escape but small enough to prevent liquid metal from escaping), and/or vent (or sacrificial) tubes may be added to allow air trapped in the modular part mold to escape during casting.

Although the present disclosure may refer to channels and connectors, one of ordinary skill will recognize that a channel from a sprue to a part mold (which enables molten material to flow from the sprue to the part mold) may be referred to as a runner, and an opening in the part mold (which enables molten material to enter the part mold) may be referred to as a gate.

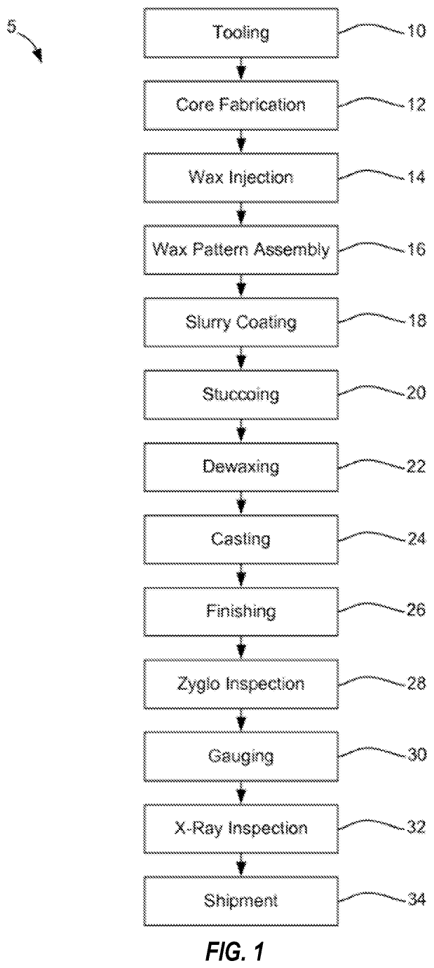

FIG. 1 is a flowchart for conventional investment casting of three-dimensional objects according. For example, the flowchart illustrated in FIG. 1 could be utilized to create turbine airfoils; turbine airfoils with extremely complex interior cooling passages are often produced by investment casting. The process 5 of FIG. 1 begins with the creation of all the tooling 10 necessary to fabricate the cores, patterns, mold, and setters for casting the items, typically involving over a thousand tools for each item. The next step involves fabrication 12 of ceramic cores by injection molding. Molten wax may also be injection molded 14 to define the patterns for the object's shape. Several such wax patterns are then assembled 16 into a wax pattern assembly or tree. The pattern assembly is then subjected to multiple rounds of slurry coating 18 and stuccoing 20 to form the completed mold assembly. The mold assembly is then placed in an autoclave for dewaxing 22. The result is a hollow ceramic shell mold into which molten metal in poured to form the castings 24. Upon solidification, the ceramic mold is broken away and the individual metal castings are separated therefrom. The castings are next finished 26, 28, 30 and inspected 32 prior to shipment 34.

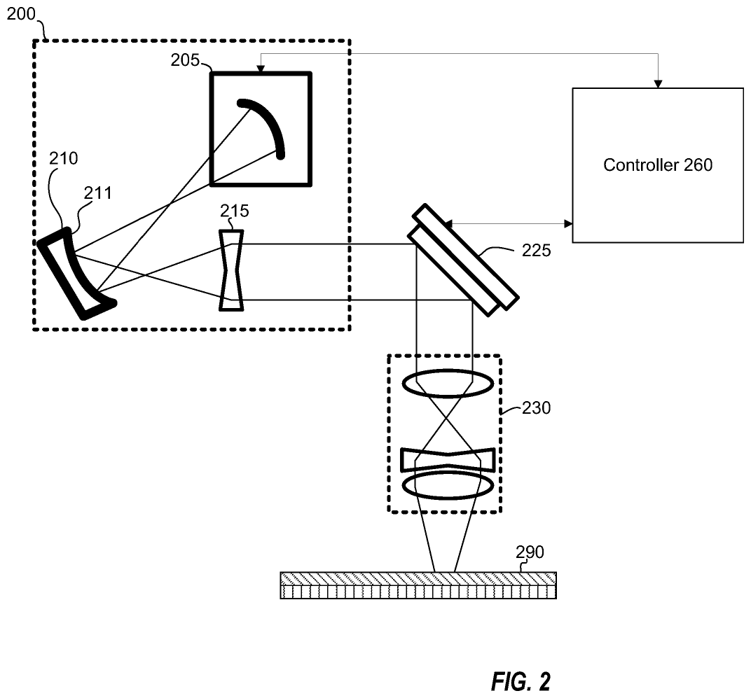

FIG. 2 illustrates a plan view of an example 3D printing system. The 3D printing system 100 for fabricating a three-dimensional object includes the optical imaging system 200. The optical imaging system 200 or radiation system includes a light source 205, a reflector system 210, an optical lens system 215, a mirror 225 (e.g., a digital micromirror device (DMD)), and a projection lens 230. The light source 205 may illuminate, and thus provide a light. Various embodiments of the present invention may include light sources comprising any one of an ultraviolet light, violet light, blue light, green light, actinic light, and the like. In an exemplary embodiment, the light source has a particular, predetermined wavelength in the UV spectrum. Embodiments of the present invention may be described herein as a UV light source, but embodiments of the present invention are not limited to such a light source, and other light sources, including the examples disclosed may be implemented.

The light emitting from the light source 205 may be projected upon a portion of the reflector system 210, and reflects from the reflector system 210, which may comprise a concave-shaped reflector 211. The reflector 211 of the reflector system 210 directs the light through a lens 216 of the optical lens system 215 before it reaches the DMD 225. The light from the DMD 225 is next directed towards the projection lens 230. The light from the projection lens 230 is then projected onto the surface 290 of the photosensitive medium. The light source 205 and DMD 225 may be controlled by a controller 260 (e.g., hardware and/or software configured to control the 3D printing system). Controller 260 may dynamically control the DMD 225 and the light source 205 to customize a 3D printed item. In some cases, the light source 205 and DMD 225 may provide feedback to the controller 260.

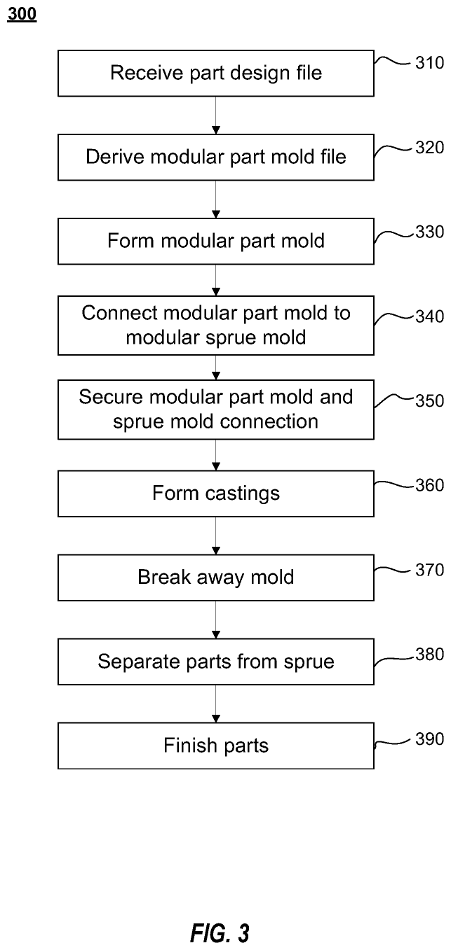

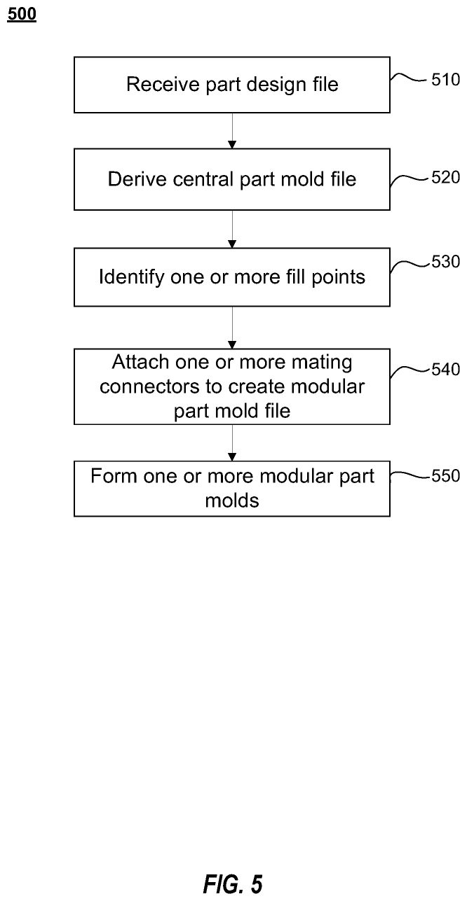

FIG. 3 is a flowchart for investment casting of 3D objects according to an example embodiment. The process 300 of FIG. 3 begins with receiving 310 receiving one or more design files (e.g., CAD files) of one or more parts to be manufactured. In some cases, the design files may be received in completed form. In other cases, a design file may be created by scanning a part (e.g., with a 3D scanner). Modular part mold files are derived 320 from the part design file(s). The modular part mold files include a virtual mating connector dimensioned to mate with a corresponding connector on a modular sprue mold. In some cases, one or more virtual channels may extend from the part mold proper (e.g., the portion of the mold file corresponding to the finished part) to the connector. Deriving 320 the modular part mold files may be substantially similar to that described below with reference to FIG. 5.

One or more modular part molds are then formed 330 (e.g., 3D printed) based on the modular part mold files. The modular part molds are connected 340 to a sprue mold by connecting the mating connectors of the modular part molds to connectors formed on a channel of the sprue mold. The connections between the part molds and the sprue mold may be secured 350 and/or sealed, such as with ceramic glue, with a connection structure (e.g., built on the connector and/or mating connector), or by clamping. Castings are formed 360 (e.g., by pouring molten metal into the assembled mold). Upon solidification, the ceramic mold is broken away 370 and the individual metal castings of the parts separated 380 therefrom and finished 390.

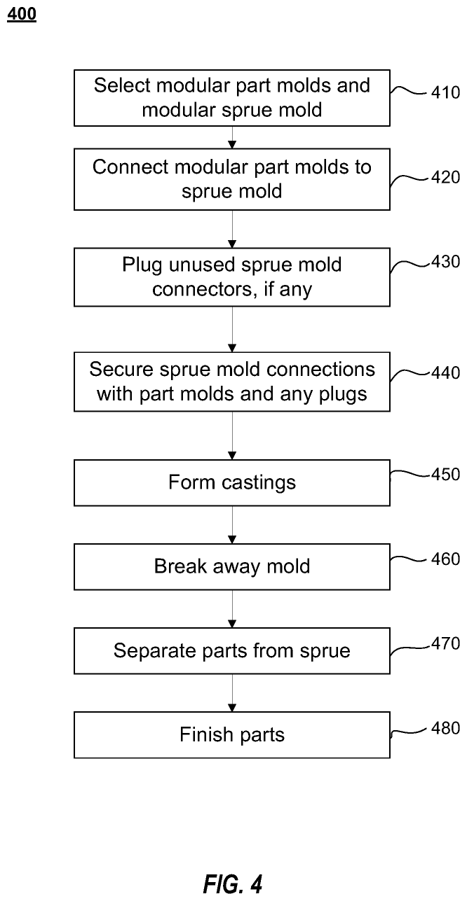

FIG. 4 is a flowchart for investment casting of three-dimensional objects according to an example embodiment. The process 400 of FIG. 4 begins with selecting 410 a plurality of modular part molds and a sized modular sprue mold. For example, a sprue mold may be selected from among a plurality of sprue molds of various lengths, thicknesses, channel size, connector size and/or spacing, and/or size of pour cup. In some cases, the pour cup can be modularly attached to a sprue after selection (e.g., a pour cup printed and/or formed separately from the sprue). In some cases, a pour cup may be integrated with the sprue (e.g., printed or otherwise formed together with the sprue). The selected modular part molds are then connected 420 to the sprue mold by connecting mating connectors of the modular part molds to corresponding connectors formed on central channel of the sprue mold. If any connectors of the sprue mold are left unused (e.g., no part mold is connected to one of the sprue mold connectors), a plug may be connected 430 to the unused sprue mold connector. In some cases, the plug may partially intrude into the channel (e.g., to minimize use of molten material during casting), or be design to snugly fit (e.g., to avoid metal spillage). One of ordinary skill will recognize that this is merely an example. In some cases, the connectors of the sprue mold may be formed “plugged” (e.g., sealed). To connect a part mold to the sprue mold, a connector of the sprue mold must be “unplugged”, such as by punching out or otherwise removing the plug. In some cases, a score line or other weakening element may be formed around the plug to aid in punching out the plug. In some cases, one or more side branches may be selected and connected to the sprue mold. Part molds may be attached to connectors on the side branches and/or sprue mold, as will be understood by one of ordinary skill in light of the present disclosure.

The connections between the part molds and the sprue mold (and the plugs and the sprue mold) may be secured 440 and/or sealed, such as with ceramic glue, clamps, and/or built—in connection structures. In some instances, no sealing is necessary. In some cases, the connectors and mating connectors may be tight fitting and require no sealing. In some instances, the connectors and mating connectors may be locking and/or threaded. In certain embodiments, the connectors and/or mating connections may be self-sealing. For example, a material at an interface surface of the connector/mating connector may melt and/or fuse the part mold and sprue mold together (e.g., when molten metal is poured 425 into the completed mold). As another example, a material at the interface surface of the connector/mating connector may have a greater thermal expansion coefficient than the ceramic mold. Thus, when the completed mold is heated (i.e., when molten metal is poured 425 into the completed mold), the material will expand sealing the connection between the part mold and the sprue mold. Castings are formed 450 (e.g., by pouring molten metal into the assembled mold). Upon solidification, the ceramic mold is broken away 460 and the individual castings of the parts are separated 470 from the sprue and finished 480.

FIG. 5 is a flowchart for producing a modular part mold according to an example embodiment. The process 500 of FIG. 5 begins with receiving 510 receiving a design file of a part. The design file may be a CAD file of a 3D design of the part. In some cases, the design file may be created by scanning (e.g., 3D scanning) a part. A central part mold file is derived 520 from the part design file. For example, the central mold file may be created by forming a virtual shell around the 3D design of the part virtually removing the part (e.g., creating a negative of the design file). For example, a surface of the 3D design may be extracted, and the surface thickened to create a shell. In some cases, the shell thickness may be varied, channels may be formed within the shell, and or different types of material may be used for different portions of the shell (e.g., to control to tailor local heat transfers for cooling a cast part).

One or more fill points are identified 530 on the central part mold file and a virtual mating connector is attached 540 to the one or more fill points, creating a modular part mold file. When formed, the mating connector can mate with a connector formed on a sprue mold. The mating connector may include one or more of locks (e.g., mating locks to form a secure connection with corresponding locks of a connector formed on a sprue mold) or threads (e.g., to match threads formed on a connector of a sprue mold). In some cases, one or more virtual channels are added to extend from one or more fill points to the virtual mating connector. During casting, the channels may provide for the flow of molten material from the connector to the central part mold. In some cases (e.g., for larger parts), a plurality of virtual connectors may be added to the central part mold file.

One or more modular part molds are then formed 550 (e.g., 3D printed) based on the modular part mold file. The modular part mold(s) may then be attached to a sprue mold and used in investment casting to produce the corresponding part. As will be understood, the modular part molds may include a central mold forming a negative of a desired part, mating connector, and (optionally) one or more channels connecting a cavity of the mating connector to a cavity of the central mold.

In some cases, an entirety of the modular part molds may be formed of a substantially similar material (e.g., ceramics), but this is merely an example. In some cases, forming 550 the modular part mold(s) may include forming a substantially different material on a portion of the mating connector (e.g., the portion or a subset of the portion of the mating connector that will interface with the connector of a sprue mold). For example, a portion of the mating connector may be formed of a material configured to fuse and/or melt to connect the part mold and sprue mold together (e.g., when molten metal is poured during casting). As another example, a portion of the mating connector may be formed of a material with a greater thermal expansion coefficient than the remaining mold, thereby sealing the connection between the mating connector and the connector (i.e., when motel metal is poured during casting). In some cases, the differing material may be added after forming 550 the mold proper (e.g., by a post-3D printing step).

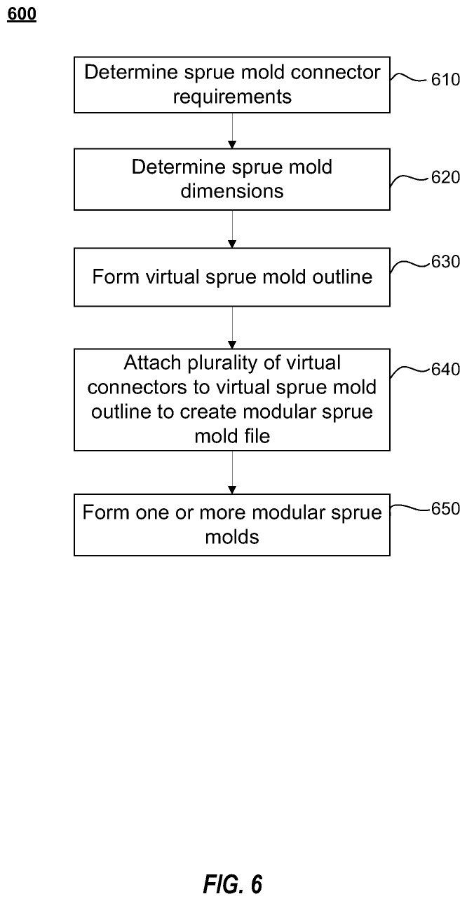

FIG. 6 is a flowchart for producing a modular sprue mold according to an example embodiment. The process 600 of FIG. 6 begins with determining 610 sprue mold connector requirements. For example, the sprue mold may include a plurality of connectors of various shapes, sizes, and spacings, the connectors being configured to connect with mating connectors of a plurality of part molds. That is, the sprue mold must be able to accommodate the desired number and dimension of part molds. Accordingly, in some cases, determining 610 the sprue mold connector requirements may include receiving identifiers of one or more parts to be casted. However, this is merely an example, and, in some cases, sprue mold connector requirements may be predetermined and/or standardized.

Sprue mold dimensions are determined 620 based on the connector requirements. Determining 620 the dimensions may include determining a sprue thickness, determining a sprue shape, determining a cup size and shape, and determining a sprue length. For instance, the resultant sprue mold must be able to accommodate the number of spacing of the connectors across the trunk of the resultant sprue. In some cases, the dimensions 620 may be determined automatically based on the connector requirements, such as with machine learning or through a CAD program (e.g., to optimally fit the connectors based on the part mold sizes). A virtual sprue mold outline is formed 630 in accordance with the determined dimensions. Virtual connectors are added 640 to the sprue mold outline, forming a sprue mold file. The virtual mating connectors may include one or more of locks (e.g., to form a secure connection with corresponding mating locks of a mating connector formed on a parts mold) or threads (e.g., to match threads formed on a mating connector of a parts mold).

One or more sprue molds are then formed 650 (e.g., 3D printed) based on the sprue mold file. Part mold(s) and/or arm molds may then be attached to the sprue mold and used in investment casting to produce the corresponding part(s). As will be understood, the sprue mold includes a central mold forming a sprue space and a plurality of connectors. In some cases, an entirety of the sprue mold may be formed of a substantially similar material (e.g., ceramics), but this is merely an example. In some cases, the connectors of the sprue mold may be formed 650 with plugs (e.g., sealed). In order to form a part (i.e., connect a part mold to the connector), the plugs must be punched-out or otherwise removed.

In some cases, forming 650 the sprue mold may include forming a substantially different material on a portion of the connector (e.g., the portion or a subset of the portion of the connector that will interface with the mating connector of a parts mold). For example, a portion of the connector may be formed of a material configured to fuse and/or melt to connect the part mold and sprue mold together (e.g., when molten metal is poured during casting). As another example, a portion of the connector may be formed of a material with a greater thermal expansion coefficient than the remaining mold, thereby sealing the connection between the mating connector and the connector (i.e., when motel metal is poured during casting). In some cases, the differing material may be added after forming 650 the mold proper (e.g., by a post-3D printing step).

One of ordinary skill will recognize that one or more modular arm molds may be produced in a substantially similar manner as that described above with reference to producing a sprue mold in FIG. 6. Any necessary modifications thereto will be apparent to one of ordinary skill in light of the present disclosure. One of ordinary skill will further recognize that connector plugs may be produced utilizing similar techniques as those described above. The plugs will be dimensioned to mate with the connectors formed in the sprue and/or arms (e.g., the connector plugs may include respective mating connectors). Any necessary modifications thereto will be apparent to one of ordinary skill in light of the present disclosure.

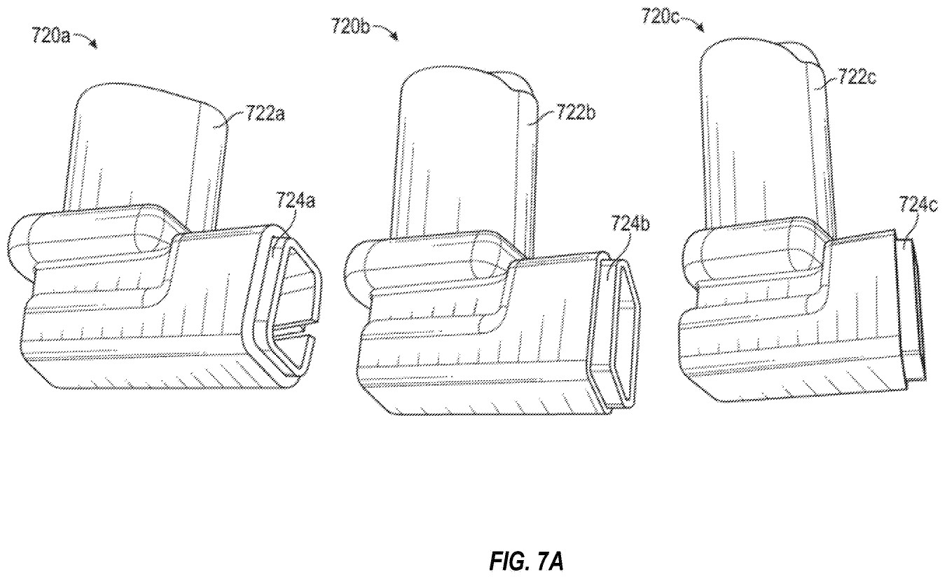

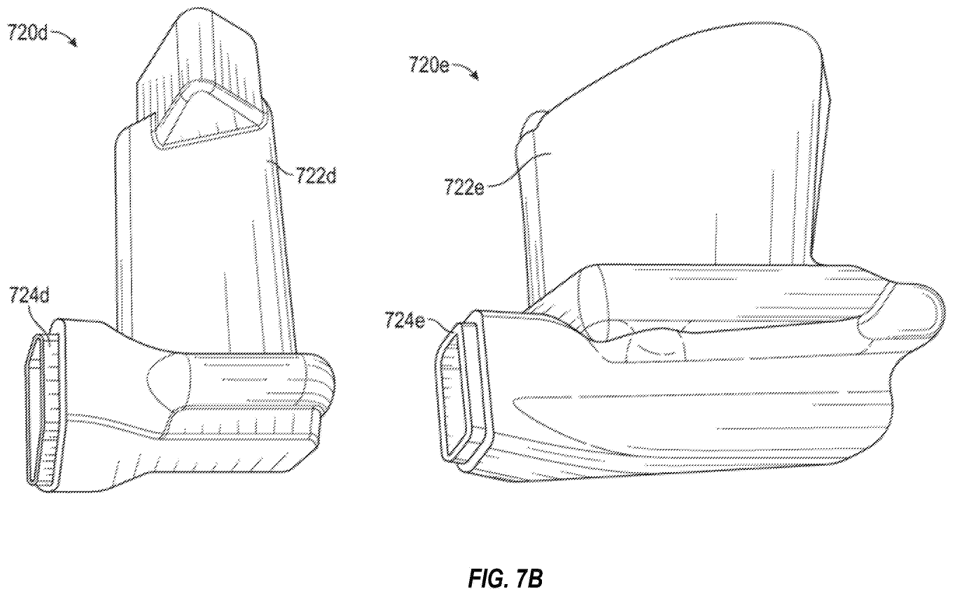

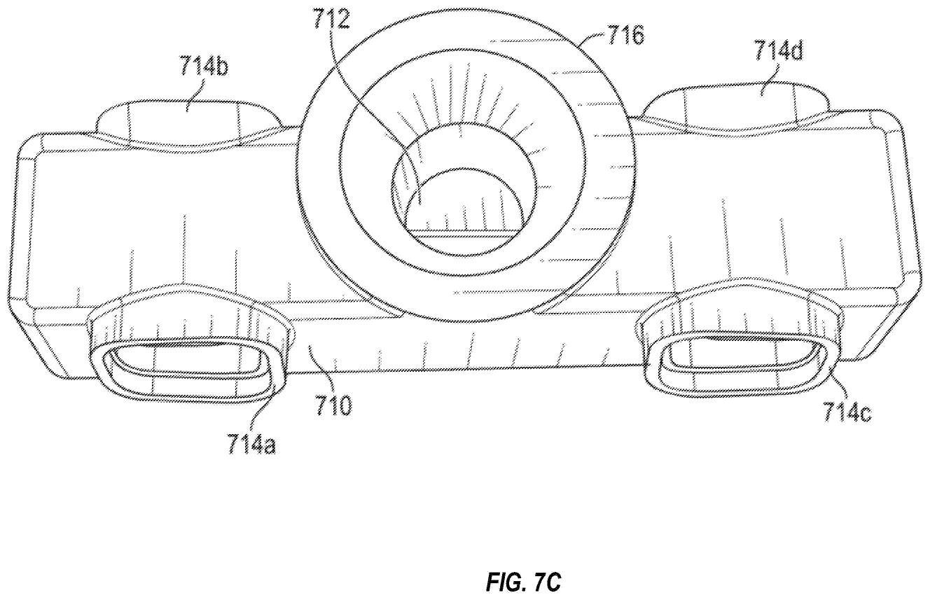

FIGS. 7A-7C illustrate a modular sprue mold and modular part molds according to an example embodiment. FIG. 7A includes three modular part molds 720a-c, FIG. 7B includes two modular part molds 720d and 720e, and FIG. 7 includes modular sprue mold 710. Sprue mold 710 includes a central void 712, four connectors 714a-d, and a filling cup 716. Although a single central void 712 and four connectors 714a-d are illustrated, this is merely an example, and a sprue mold 710 may be formed having a plurality of central voids 712, and a substantially arbitrary number of connectors 714. Furthermore, a dimension (e.g., length, thickness, void girth) of a sprue mold 710 may be substantially arbitrary based on specific needs (e.g., number, size, and shape of parts and casting material). Each part mold 720a-720e includes a respective central part mold 722a-e and a respective mating connector 724a-e. The connectors 714a-d and mating connectors 724a-e are dimensioned to fit together (e.g., mate).

The connectors 714a-d and mating connectors 724a-e may include respective locks and/or threads. In some embodiments, an interfacing surface of one or more of the connectors 714a-d and mating connectors 724a-e may include a material that may melt and/or fuse the part mold 720a-e and sprue mold 710 together (e.g., when molten metal is poured into the completed mold). As another example, a material at the interface surface of the connector 714a-d/mating connector 724a-e may have a greater thermal expansion coefficient than the remainder of the sprue mold 710 and/or part molds 720a-e. Thus, when the completed mold is heated (i.e., when motel metal is poured into the completed mold), the material will expand sealing the connection between the part mold 720a-e and the sprue mold 710.

In some implementations, there may be provided external plugs that may include mating connectors (e.g., similar to mating connectors 724a-e) dimensioned to mate with the connectors 714a-d. If a connector is not to be used (i.e., no part mold 720a-e is to be connected to the connector 714a-d) an external plug will be inserted therein. In some embodiments, the connectors 714a-d may include respective plugs that seal the connectors 714a-d. In order to utilize the connector 714a-d, the plugs must be knocked out or otherwise removed. In some implementations, there may be provided one or more modular arm molds or branch molds with a mating connector and one or more connectors. The arm molds connect to the sprue mold 710 and one or more modular part molds 720a-e. The arm mold may be used to accommodate part molds 720a-e of incompatible sizes (e.g., to space one modular part mold 720a-e from the other modular part molds 720a-e) and/or to enable the simultaneous casting of additional parts (e.g., to cast five parts 722a-e on a slue mold 710 with only four connectors 714a-d).

In some cases, one or more channels are added to extend from central part molds 722a-e to the mating connectors 724a-e. During casting, the channels may provide for the flow of molten material from the mating connector 724a-e to the central part mold 722a-e. In some cases, a part mold 720 may include a plurality of mating connectors 724, which may then mate with a plurality of connectors 714 of the sprue mold 710.

In some cases, a plurality of casting modules (e.g., modular sprue mold(s), modular part mold(s), modular arm mold(s), and/or connector plugs) may form a modular casting kit.

An embodiment of the present disclosure may be implemented according to at least the following:

Clause 1: A method comprising: obtaining a part design file of a part; deriving, from the art design file, a central mold design; determining one or more fill points for the central mold design; and attaching one or more mating connectors to the determined one or more fill points to create a modular part mold file.

Clause 2: The method of Clause 1, wherein obtaining the part design file comprises receiving a three-dimensional scan of the part.

Clause 3: The method of Clause 1 or Clause 2, wherein obtaining the part design file comprises performing a three-dimensional scan of the part with three-dimensional scanner.

Clause 4: The method of any of Clauses 1-3, wherein deriving the central mold design comprises forming a virtual shell around a three-dimensional representation of the part and removing the three-dimensional representation of the part.

Clause 5: The method of any of Clauses 1-4, wherein deriving the central mold design comprises: extracting a surface topography of the part from the part design file; and thickening the surface to create a shell.

Clause 6: The method of any of Clauses 1-5, wherein the central mold design includes a shell.

Clause 7: The method of Clause 6 further comprising at least one from among varying the thickness of the shell, forming channels within the shell, and adjusting material selection for different portions of the shell.

Clause 8: The method of Clause 7, wherein the at least one from among varying the thickness of the shell, forming channels within the shell, and adjusting material selection for different portions of the shell is based on local heat transfer requirements of one or portions of the part.

Clause 9: The method of Clause 7 or Clause 8, wherein the at least one from among varying the thickness of the shell, forming channels within the shell, and adjusting material selection for different portions of the shell is based on localized cooling requirements to control crystal formulation during casting of the part with a modular part mold generated from the modular part mold file.

Clause 10: The method of any of Clauses 7-9, further comprising forming, within the shell at least one from among vents, venting seams, and porous outlets.

Clause 11: The method of Clause 10, wherein, during casting of the part with a modular part mold generated from the modular part mold file, the vents, venting seams, and porous outlets are dimensioned to enable air to escape the mold, but small enough to prevent liquid metal from escaping the mold.

Clause 12: The method of any of Clauses 1-11, wherein the one or more mating connectors comprises one or more of one or more locks, one or more threads, or one or more locks and one or more threads.

Clause 13: The method of Clause 12, wherein the one or more locks are configured to form a secure connection with corresponding locks of a connector formed on a sprue mold.

Clause 14: The method of Clause 12 or Clause 13, wherein the one or more threads are configured to match threads formed on a connector of a sprue mold.

Clause 15: The method of any of Clauses 1-14 further comprising adding one or more virtual channels extending from the one or more fill points, the mating connectors being attached to a distal end of the one or more channels.

Clause 16: The method of any of Clauses 1-15 further comprising adding one or more sacrificial tubes extending from the central mold file to enable air to escape the mold during casting.

Clause 17: The method of any of Clauses 1-16, further comprising printing a mold based on the modular part mold file.

Clause 18: The method of Clause 17, wherein printing the mold comprises forming a portion of the mating connector of a material configured to fuse to connect the part mold and sprue mold together.

Clause 19: The method of Clause 17 or Clause 18, wherein printing the mold comprises printing a portion of the mating connector of a material having a greater thermal expansion than a main portion of the mold.

Clause 20: A method comprising: obtaining sprue mold connector requirements; deriving, from the sprue mold connector requirements, sprue mold dimensions; generating a sprue mold outline in accordance with the sprue mold dimensions; and attaching one or more virtual connectors to the sprue mold outline to create a sprue mold file.

Clause 21: The method of Clause 20, wherein receiving the sprue mold connector requirements comprises receiving identifiers of one or more parts to be casted and determining the sprue mold connector requirements based on the identified one or more parts.

Clause 22: The method of Clause 20 or Clause 21, wherein deriving the sprue mold dimensions comprises determining at least one from among a sprue thickness, a sprue shape, a cup size and shape, and a sprue length.

Clause 23: The method of any of Clauses 20-22, wherein the one or more virtual connectors comprises one or more of one or more locks, one or more threads, or one or more locks and one or more threads.

Clause 24: The method of Clause 23, wherein the one or more locks are configured to form a secure connection with corresponding locks of a connector formed on a part mold.

Clause 25: The method of Clause 23 or Clause 24, wherein the one or more threads are configured to match threads formed on a connector of a part mold.

Clause 26: The method of any of Clauses 20-25, the one or more virtual connectors comprise respective one or more plugs.

Clause 27: The method of Clause 26, wherein the one or more plugs comprises a score line around an edge of the plug.

Clause 28: The method of any of Clauses 20-27, further comprising printing a sprue mold based on the sprue mold file.

Clause 29: The method of Clause 28, wherein printing the sprue mold comprises forming a portion of the mating connector of a material configured to fuse to connect the sprue mold and a part mold together.

Clause 30: The method of Clause 28 or Clause 29, wherein printing the sprue mold comprises printing a portion of the mating connector of a material having a greater thermal expansion than a main portion of the sprue mold.

Clause 31: A modular part mold comprising: a shell defining a central void; and a mating connector attached to the shell and configured to mate with a connector of a modular sprue mold at an interface surface of the mating connector.

Clause 32: The modular part mold of Clause 31, wherein the interface surface comprises one or more of one or more locks, one or more threads, or one or more locks and one or more threads.

Clause 33: The modular part mold of Clause 32, wherein the one or more locks are configured to form a secure connection with corresponding locks of the connector of the sprue mold.

Clause 34: The modular part mold of Clause 32 or Clause 33, wherein the one or more threads are configured to match threads formed on the connector of the sprue mold.

Clause 35: The modular part mold of any of Clauses 31-34, wherein a material forming at least a portion of the interface surface has a greater thermal expansion than a material forming the shell.

Clause 36: The modular part mold of any of Clauses 31-35, wherein a material forming at least a portion of the interface surface is configured to fuse to the connector of the sprue mold.

Clause 37: The modular part mold of any of Clauses 31-36 further comprising a channel formed between the shell and the mating connector.

Clause 38: The modular part mold of any of Clauses 31-37 further comprising a plurality of channels formed between the shell and the mating connector.

Clause 39: The modular part mold of any of Clauses 31-38, wherein the shell comprises at least one from among vents, venting seams, and porous outlets.

Clause 40: The modular part mold of Clause 39, wherein the vents, venting seams, and porous outlets are dimensioned such that, during casting of a part with the modular part mold, air may escape the central void, but small enough to prevent liquid metal from escaping the central void.

Clause 41: The modular part mold of any of Clauses 31-40 further comprising one or more sacrificial tubes extending from the shell to enable air to escape the central void during casting.

Clause 42: The modular part mold of any of Clauses 31-41, wherein at least one from among a thickness of the shell varies, channels are formed within the shell, and a material of different portions of the shell differs.

43: The modular part mold of Clause 42, wherein the at least one from among the varied shell thickness, presence of the channels within the shell, and the different material selection for different portions of the shell is based on local heat transfer requirements of one or portions of a part formed from the modular part mold.

Clause 44: The modular part mold of Clause 42 or Clause 43, wherein the at least one from among the varied shell thickness, presence of the channels within the shell, and the different material selection for different portions of the shell is based on localized cooling requirements to control crystal formulation during casting of a part with the modular part mold.

Clause 45: A modular sprue mold comprising: a shell defining a central void; a plurality of mating connector attached to the shell and configured to mate with a respective connectors of one or more modular part molds at an interface surface of the mating connector; and a fill cup.

Clause 46: The modular sprue mold of Clause 45, wherein the interface surface comprises one or more of one or more locks, one or more threads, or one or more locks and one or more threads.

Clause 47: The modular sprue mold of Clause 46, wherein the one or more locks are configured to form a secure connection with corresponding locks of the connector of the modular part mold.

Clause 48: The modular sprue mold of Clause 46 or Clause 47, wherein the one or more threads are configured to match threads formed on the connector of the modular part mold.

Clause 49: The modular sprue mold of any of Clauses 45-48, wherein a material forming at least a portion of the interface surface has a greater thermal expansion than a material forming the shell.

Clause 50: The modular sprue mold of any of Clauses 45-49, wherein a material forming at least a portion of the interface surface is configured to fuse to the connector of the modular part mold.

Clause 51: The modular sprue mold of any of Clauses 45-50 further comprising one or more external plugs configured to mate to one or more of the mating connectors.

Clause 52: The modular sprue mold of any of Clauses 45-51 further comprising one or more removable plugs mated to respective mating connectors of the plurality mating connectors.

Clause 53: The modular sprue mold of any of Clauses 45-52 further comprising one or more seals sealing respective mating connectors of the plurality mating connectors.

Clause 54: The modular sprue mold of Clause 53, wherein the one or more seals are configured to be removed prior to connecting a connector of a parts mold to the respective mating connector.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
obtaining a part design file of a part;
deriving, from the art design file, a central mold design;
determining one or more fill points for the central mold design; and
attaching one or more mating connectors to the determined one or more fill points to create a modular part mold file.

2-3. (canceled)

4. The method of claim 1, wherein deriving the central mold design comprises forming a virtual shell around a three-dimensional representation of the part and removing the three-dimensional representation of the part.

5. The method of claim 1, wherein deriving the central mold design comprises:
extracting a surface topography of the part from the part design file; and
thickening the surface to create a shell.

6. The method of claim 1, wherein the central mold design includes a shell.

7. The method of claim 6 further comprising at least one from among varying the thickness of the shell, forming channels within the shell, and adjusting material selection for different portions of the shell.

8. The method of claim 7, wherein the at least one from among varying the thickness of the shell, forming channels within the shell, and adjusting material selection for different portions of the shell is based on local heat transfer requirements of one or portions of the part.

9. The method of claim 7, wherein the at least one from among varying the thickness of the shell, forming channels within the shell, and adjusting material selection for different portions of the shell is based on localized cooling requirements to control crystal formulation during casting of the part with a modular part mold generated from the modular part mold file.

10. The method of claim 7, further comprising forming, within the shell at least one from among vents, venting seams, and porous outlets.

11. The method of claim 10, wherein, during casting of the part with a modular part mold generated from the modular part mold file, the vents, venting seams, and porous outlets are dimensioned to enable air to escape the mold, but small enough to prevent liquid metal from escaping the mold.

12. The method of claim 1, wherein the one or more mating connectors comprises one or more of one or more locks, one or more threads, or one or more locks and one or more threads, the one or more locks or the one or more threads being configured to connect with corresponding locks or threads of a connector formed on a sprue mold.

13-14. (canceled)

15. The method of claim 1 further comprising adding one or more virtual channels extending from the one or more fill points, the mating connectors being attached to a distal end of the one or more channels.

16. The method of claim 1 further comprising adding one or more sacrificial tubes extending from the central mold file to enable air to escape the mold during casting.

17. The method of claim 1, further comprising printing a mold based on the modular part mold file.

18-19. (canceled)

20. A method comprising:
obtaining sprue mold connector requirements;
deriving, from the sprue mold connector requirements, sprue mold dimensions;
generating a sprue mold outline in accordance with the sprue mold dimensions; and
attaching one or more virtual connectors to the sprue mold outline to create a sprue mold file.

21. The method of claim 20, wherein receiving the sprue mold connector requirements comprises receiving identifiers of one or more parts to be casted and determining the sprue mold connector requirements based on the identified one or more parts.

22. The method of claim 20, wherein deriving the sprue mold dimensions comprises determining at least one from among a sprue thickness, a sprue shape, a cup size and shape, and a sprue length.

23-25. (canceled)

26. The method of claim 20, the one or more virtual connectors comprise respective one or more plugs, the one or more plugs comprising a score line around an edge of the plug.

27. (canceled)

28. The method of claim 20, further comprising printing a sprue mold based on the sprue mold file, printing the sprue mold comprising forming a portion of the mating connector of a material configured to fuse to connect the sprue mold and a part mold together.

29-30. (canceled)

31. A modular part mold comprising:
a shell defining a central void; and
a mating connector attached to the shell and configured to mate with a connector of a modular sprue mold at an interface surface of the mating connector.

32-37. (canceled)

38. The modular part mold of claim 31 further comprising a plurality of channels formed between the shell and the mating connector.

39-54. (canceled)
